(19) United States
(12) Patent Application Publication
(10) Pub. No.: US 2015/0317418 A1
(43) Pub. Date: Nov. 5, 2015

(54) PROVIDING THREE-DIMENSIONAL MONITORING OF A FACILITY

(71) Applicant: Honeywell International Inc., Morristown, NJ (US)

(72) Inventors: Rajesh Kulandaivel Sankarapandian, Madurai (IN); Kirupakar Janakiraman, Madurai (IN)

(73) Assignee: Honeywell International Inc., Morristown, NJ (US)

(21) Appl. No.: 14/268,380

(22) Filed: May 2, 2014

(51) Int. Cl. G06F 17/50

(52) U.S. Cl. CPC G06F 17/5009

(57) ABSTRACT

Methods, systems, and devices for providing three-dimensional monitoring of a facility are described herein. One method includes generating a 3D model of a facility based on building information modeling data associated with the facility, receiving facility status information determined by at least one device associated with a portion of the facility, and displaying an updated 3D model of the facility using the facility status information.

### TECHNICAL FIELD

The present disclosure relates to methods, systems, and devices for providing three-dimensional monitoring of a facility.

### BACKGROUND

Monitoring facilities (e.g., buildings, plants, refineries, etc.) can allow for enhanced security, safety, intrusion detection, and/or response time, for instance. Facility monitoring may include the use of one or more physical security information management (PSIM) applications. PSIM applications can integrate multiple applications and/or devices and allow a user access and/or control through a user interface.

Previous approaches to facility monitoring may use geographic information system (GIS) maps. As facilities grow in size, users may find previous approaches to facility monitoring cumbersome and/or time consuming. For example, navigating to a specific point (e.g., a point of interest) in a facility using previous approaches may cost the user valuable time needed to detect and/or respond to a threat. Further, previous approaches may lack contextual information and may therefore present the issue of navigating between various pages and/or displays. Additionally, previous approaches may inhibit user navigation (e.g., virtual navigation) through a facility.

### BRIEF DESCRIPTION OF THE DRAWINGS

FIG. 1 illustrates a system for providing three-dimensional monitoring of a facility in accordance with one or more embodiments of the present disclosure.

FIG. 2 illustrates a method for providing three-dimensional monitoring of a facility in accordance with one or more embodiments of the present disclosure.

### DETAILED DESCRIPTION

Devices, methods, and systems for providing three-dimensional (3D) modeling of a facility are described herein. For example, one or more embodiments include generating a 3D model of a facility based on building information modeling data associated with the facility, receiving facility status information determined by at least one device associated with a portion of the facility, and displaying an updated 3D model of the facility using the facility status information.

Facility monitoring in accordance with one or more embodiments of the present disclosure can model (e.g., depict) a portion of a facility (e.g., a floor of the facility) in interactive 3D. The facility model can include virtual objects, for instance. Virtual objects can include representations of portions of the facility and/or objects therein. For example, virtual objects can represent portions the facility floor plan, equipment (e.g., sensors, machines, etc.), and others. Virtual objects can be acquired (e.g., extracted) from a building information model (BIM) and/or BIM data associated with the facility.

The virtual objects can reflect the status (e.g., real-time status) of the facility, which can be determined though integration with various systems associated with the facility. Such systems can include, for example, access control systems, video systems, communications systems, notification systems, fire alarm systems, elevator systems, chemical, biological, radiological, and nuclear (CBRN) defense systems, biometric systems, geographical information systems (GIS), heating, ventilation, and air conditioning (HVAC) systems, automated bollard systems, building management systems, air purging systems, radio frequency identification systems, etc. Embodiments of the present disclosure can allow users to visualize intuitive alarms with real-time effects and intensities associated with alarms occurring within the facility.

Embodiments of the present disclosure can include a user interface (e.g., display). The display can be a head-mounted display (HMD), a video wall, and/or a mobile display, among other displays. Using the display, a user can interact with virtual objects of the model. Such interaction can include, for example, determining (e.g., displaying) more information about a particular object (e.g., a status of the object), changing a status (e.g., activating, deactivating, adjusting, etc.) a device associated with (e.g., represented by) an object, etc. In some embodiments, the user can control and/or command the live status of devices and/or equipment represented by objects in the 3D model.

Interaction with virtual objects can be accomplished in various manners. In some embodiments, interaction with virtual objects may include user contact with the display (e.g., in embodiments where the display includes a touch screen display). In other embodiments, interaction with virtual objects may not include user contact with the display. For example, embodiments of the present disclosure can recognize user gestures (e.g., hand movements) and/or user position. Further, embodiments of the present disclosure can utilize eye tracking capabilities to allow the user to interact with virtual objects (e.g., in embodiments using an HMD), for instance. It is to be understood that embodiments of the present disclosure do not limit manners of object interaction and that other manners of interaction (e.g., using a keyboard and/or mouse) are in accordance with the present disclosure.

In addition, embodiments of the present disclosure can allow a user to navigate through the model of the facility via a plurality of navigation modes. Such modes are described further below and can include, for example, autopilot mode, walkthrough mode, mini map mode, click & view mode, etc. The user can switch between the modes at will (e.g., via one or more inputs).

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing. Similar elements or components between different figures may be identified by the use of similar digits.

As used herein, “a” or “a number of” something can refer to one or more such things. For example, “a number of structures” can refer to one or more structures.

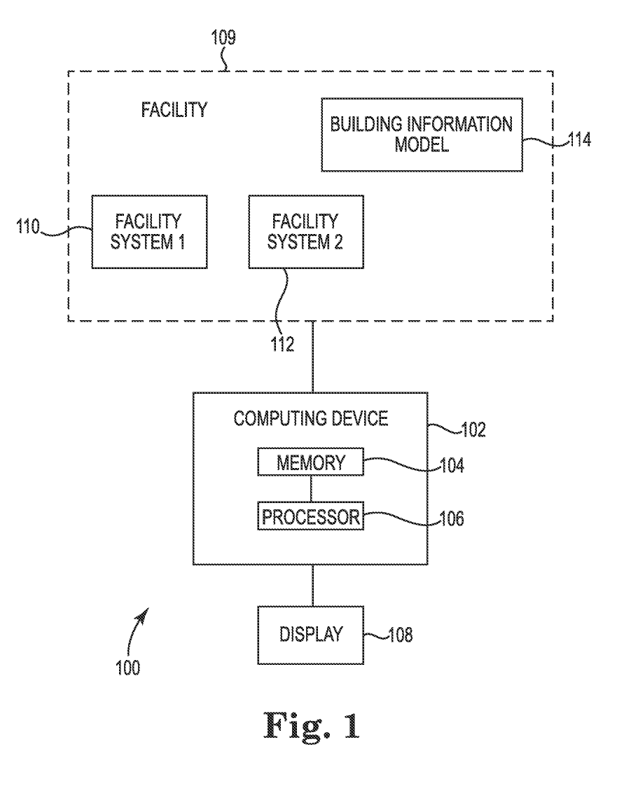

FIG. 1 illustrates a system 100 for providing three-dimensional monitoring of a facility in accordance with one or more embodiments of the present disclosure. As shown in FIG. 1, system 100 can include a computing device 102, having a memory 104 and a processor 106, a display 108, a facility 109, a first facility system 110, a second facility system 112, and a building information model (BIM) 114.

Though the first facility system 110, the second facility system 112, and the BIM 114 are illustrated as being within the facility 109, such illustration is meant to convey that the first facility system 110, the second facility system 112, and the BIM 114 are associated with the facility 109. Further, though two facility systems are shown in FIG. 1 for purposes of clarity, embodiments in accordance with the present disclosure can include more or fewer facility systems.

Computing device 102 can be, for example, a laptop computer, a desktop computer, or a mobile device (e.g., a mobile phone, a personal digital assistant, etc.), among other types of computing devices. As shown in FIG. 1, computing device 102 includes a memory 104 and a processor 106 coupled to memory 104. Memory 104 can be any type of storage medium that can be accessed by processor 106 to perform various examples of the present disclosure. For example, memory 104 can be a non-transitory computer readable medium having computer readable instructions (e.g., computer program instructions) stored thereon that are executable by processor 106 to provide 3D monitoring of a facility in accordance with one or more embodiments of the present disclosure.

Memory 104 can be volatile or nonvolatile memory. Memory 104 can also be removable (e.g., portable) memory, or non-removable (e.g., internal) memory. For example, memory 104 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical disk storage, and/or a magnetic medium such as magnetic cassettes, tapes, or disks, among other types of memory.

Further, although memory 104 is illustrated as being located in computing device 102, embodiments of the present disclosure are not so limited. For example, memory 104 can also be located internal to another computing resource (e.g., enabling computer readable instructions to be downloaded over the Internet or another wired or wireless connection).

The display 108 (e.g., screen) can be configured to display one or more embodiments herein for instance. Though display 108 is shown as being external to computing device 102, display 108 can be included as a portion of computing device 102.

In some embodiments, the display 108 can be a head-mounted display (HMD), for instance (e.g., head-mounted glasses). In other embodiments, the display can be a video wall. In such a display, a user (e.g., a security operator) can simultaneously display information from multiple facility systems on an interactive interface (e.g., video wall). In other embodiments, the display 108 can be a mobile device (e.g., mobile phone, tablet, personal digital assistant (PDA), etc.). In various embodiments, more than one display can be utilized. The display can be, for instance, a touch-screen (e.g., the display can include touch-screen capabilities).

The display 108 can provide (e.g., display and/or present) information to a user (e.g., a user using computing device 102). Computing device 102 can receive information from a user through an interaction with the user via the display 108. For example, computing device 102 can receive inputs from the user via the display 108. The user can enter the input into computing device 102 using, for instance, a mouse and/or keyboard associated with computing device 102, or by touching the display in embodiments in which the display includes touch-screen capabilities (e.g., embodiments in which the display is a touch screen).

In other embodiments, interaction with the display 108 may not include user contact with the display 108. For example, embodiments of the present disclosure can recognize user gestures (e.g., hand movements) and/or user position. Further, embodiments of the present disclosure can utilize eye tracking capabilities to allow the user to interact with various objects of a facility (e.g., in embodiments using an HMD), for instance.

The facility 109 can be a number of structures (e.g., portions and/or combinations of structures) and facilities in accordance with embodiments herein are not limited to particular types of facilities. For example, the facility 109 can be a building, a plant, an installation, a refinery, etc.

The first facility system 110 and/or the second facility system 112 can be systems and/or device(s) associated with a respective aspect (e.g., a portion) of the facility 109. As previously discussed, such systems can include, for example, access control systems, video systems, communications systems, notification systems, fire alarm systems, elevator systems, chemical, biological, radiological, and nuclear (CBRN) defense systems, biometric systems, geographical information systems (GIS), heating, ventilation, and air conditioning (HVAC) systems, automated bollard systems, building management systems, air purging systems, radio frequency identification systems, etc., though embodiments of the present disclosure are not limited to particular facility systems.

The first facility system 110 and/or the second facility system 112 can each be an individual device (e.g., a video camera and a card reader, respectively). The first facility system 110 and/or the second facility system 112 can be systems including a plurality of devices (e.g., a video surveillance system and an access control system, respectively). In various embodiments, the first facility system 110 and/or the second facility system 112 can include one or more sensing devices. The first facility system 110 and/or the second facility system 112 may be occasionally referred to herein as “the facility systems.”

The BIM 114 can include a digital representation of physical and functional characteristics of the facility 109. The BIM can include three-dimensional (3D) renderings of the facility 109 (e.g., a 3D model of the facility 109) and information associated therewith (e.g., geometry, spatial relationships, geographic information, properties of components, etc.). The BIM 109 can include a plurality of objects (e.g., virtual objects), for instance. Objects can represent facility floor plan(s), equipment (e.g., devices, machines, vehicles, sensors, etc.).

The computing device 102 can receive the BIM 114 and store the BIM 114 in the memory 104, for instance. In some embodiments, the BIM 114 can be stored in a data repository associated with the facility 109.

The computing device 102 can receive information (e.g., facility status information, facility alarm information, etc.) from each of the first facility system 110 and the second facility system 112. The information can be received in real time (e.g., substantially in real time), as it is determined, and/or at a particular interval. The computing device 102 can use the received information to update and/or supplement (e.g., augment) the BIM 114. That is, in some embodiments, the BIM 114 (e.g., a portion of the BIM 114) and the received information (e.g., a portion of the received information) can be displayed simultaneously. Displaying the BIM and the received information simultaneously can include overlaying the received information on the BIM, in some embodiments.

For example, the information can include video images determined by the first facility system 110 (e.g., in an embodiment where the first facility system 110 is a surveillance system). In some embodiments, the information can include information associated with a current emergency in the facility, an alarm, and/or an event. Additionally, location(s) and/or movement of people, assets, vehicles, etc. can be displayed using location identification services (e.g., global positioning system (GPS)).

The BIM 114 can be displayed as a 3D model using the display 108. In various embodiments, a physical presence within and/or outside the facility can be simulated by the display 108 (e.g., using virtual reality and/or 3D). 3D displays can provide an unambiguous visual representation of the spatial structure of the facility 109 with customizable effects, for instance.

In various embodiments, the computing device 102 can receive information from the facility systems that indicates an event and/or an alarm (e.g., event information and/or alarm information). The computing device 102, via the display 108, can render a 3D simulation of the event and/or the alarm over the 3D model of the facility. The objects of the BIM 114 can reflect the information received from the facility systems (e.g., live status of the building). Accordingly, a user can visualize intuitive alarms with real time effects and/or actual intensity.

Computing device 102 can render a 3D simulation of an event in the facility 109 over the 3D BIM 114. For example, a fire alarm in the facility 109 can be displayed over the BIM 114 during the alarm. In addition to the alarm itself, a location of the fire (e.g., determined based on sensor readings) can be displayed (e.g., using one or more 3D animations of a fire). Embodiments can use material animations and/or effects to reproduce (e.g., display) real-world intensity associated with events, alarms, faults, and/or emergencies, enabling situational awareness not available under previous approaches.

Alarms can be displayed in an intuitive manner, for instance. In some embodiments, the alarm displayed can depend upon the object associated with the alarm. For example, a determined intrusion over a fence can be shown as a color change of the fence. In another example, once a location of an alarm is determined, embodiments of the present disclosure can cause the display of a portion of the BIM 114 corresponding to the determined location.

A user can interact with objects of the BIM 114 in various manners. In some embodiments, interaction with objects may include user contact with the display 108 (e.g., in embodiments where the display 108 includes a touch screen display). In other embodiments, interaction with objects may not include user contact with the display 108. For example, embodiments of the present disclosure can recognize user gestures (e.g., hand movements) and/or user position.

Further, embodiments of the present disclosure can utilize eye tracking capabilities to allow the user to interact with virtual objects (e.g., in embodiments using an HMD), for instance. It is to be understood that embodiments of the present disclosure do not limit manners of object interaction and that other manners of interaction (e.g., using a keyboard and/or mouse associated with computing device 102) are in accordance with the present disclosure.

A user can interact with equipment (e.g., devices) of the facility by interacting with the object(s) used to represent them in the BIM 114. Interactions with equipment can include, for example, acknowledging alarms, activating camera feeds, requesting device information (e.g., device attributes), etc. Additionally, the user can activate and/or deactivate visibility of information received from the facility systems by interactions with the display 108 and/or the computing device 102.

A user can cause the display of a particular portion of the information received from the facility systems corresponding to a particular facility system (e.g., the first facility system 110) responsive to a selection of the particular facility system. For example, the user can select a surveillance system (e.g., from a menu) in order to cause display of the information received from the surveillance system (e.g., live and/or archived video feed(s)).

As previously discussed, embodiments of the present disclosure can allow a user to navigate through the BIM 114 of the facility 109 via a plurality of navigation modes. Such modes can include, for example, autopilot mode, walkthrough mode, mini map mode, click & view mode, etc. The user can switch between the modes at will (e.g., via one or more inputs made into the display 108 and/or the computing device 102).

The various navigation modes can allow a user to visualize the facility at a high level and/or drill down to specific locations within the facility. In some embodiments, a user can navigate through a portion of the BIM 114 of the facility 109 as if the user was navigating the corresponding portion of the facility itself on foot. Other embodiments allow a user to simulate a flight over the facility to view high-level activities.

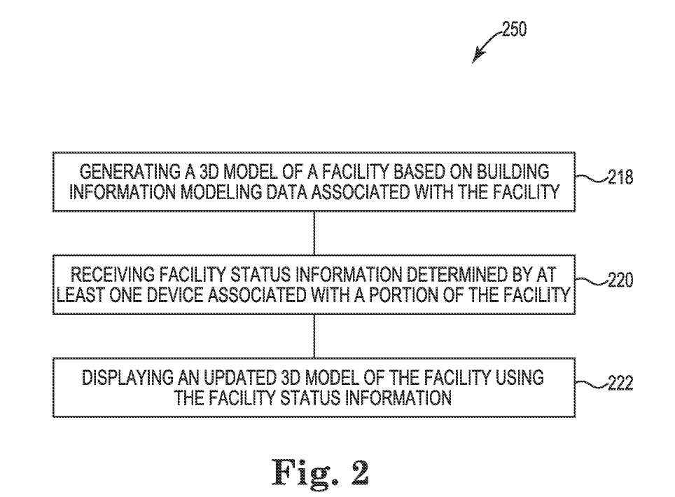

FIG. 2 illustrates a method 216 for providing three-dimensional monitoring of a facility in accordance with one or more embodiments of the present disclosure. Method 216 can be performed by a computing device (e.g., computing device 102, previously described in connection with FIG. 1), for instance.

At block 218, method 216 includes generating a 3D model of a facility based on building information modeling data associated with the facility. Building information modeling data can be included in a BIM (e.g., BIM 114 previously described in connection with FIG. 1).

At block 220, method 216 includes receiving facility status information determined by at least one device associated with a portion of the facility. As previously discussed, facility status information can be received from facility systems (e.g., first facility system 110 and/or second facility system 112, previously described in connection with FIG. 1), for instance. The facility systems can include one or more devices. The devices can be associated with a geographic portion of a facility (e.g., a wing of a facility) and/or a particular facility system associated with the facility (e.g., an alarm system of a facility).

At block 222, method 216 includes displaying an updated 3D model of the facility using the facility status information. As previously discussed, the BIM can be updated and/or supplemented (e.g., augmented) using the facility status information. In some embodiments, the BIM (e.g., a portion of the BIM) and the received information (e.g., a portion of the received information) can be displayed simultaneously. The simultaneous display of such information with the 3D model may be referred to as an updated 3D model of the facility.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for providing three-dimensional (3D) facility monitoring, comprising:
generating a 3D model of a facility based on building information modeling data associated with the facility;
receiving facility status information determined by at least one device associated with a portion of the facility; and
displaying an updated 3D model of the facility using the facility status information.

2. The method of claim 1, wherein displaying the updated 3D model includes displaying at least a portion of the facility status information and at least a portion of the 3D model simultaneously.

3. The method of claim 1, wherein the method includes simulating a physical presence at a particular location in the updated 3D model.

4. The method of claim 3, wherein the method includes allowing a user to navigate the updated 3D model via each of a plurality of navigation modes.

5. The method of claim 1, wherein the facility status information is determined using at least one sensing device of an access control system associated with the facility.

6. The method of claim 1, wherein the method includes receiving the facility status information from at least one sensing device, and wherein the method includes generating the 3D model of the facility using a plurality of virtual objects received from a data repository associated with the facility.

7. The method of claim 1, wherein the updated 3D model includes a plurality of virtual objects, and wherein the method includes allowing a user to interact with an object of the plurality of objects via a gesture.

8. The method of claim 1, wherein the method includes displaying the updated 3D model using a head-mounted display.

9. A system for providing 3D facility monitoring, comprising:
a plurality of systems, each associated with a respective aspect of a facility;
a computing device, configured to:
receive information from each of the plurality of systems; and
supplement a 3D model of the facility with the received information; and
a user device, configured to:
receive a portion of the supplemented 3D model; and
display the portion of the supplemented 3D model.

10. The system of claim 9, wherein the plurality of systems includes an access control system, a video system, a communications system, a notification system, a fire alarm system, an elevator system, a chemical, biological, radiological, and nuclear (CBRN) defense system, a biometric system, a geographical information system (GIS), an automated bollard system, a building management system, an air purging systems, and a radio frequency identification system.

11. The system of claim 9, wherein the computing device is configured to receive the information from each of the plurality of systems substantially in real time.

12. The system of claim 9, wherein the received information includes information associated with a current emergency in the facility.

13. The system of claim 9, wherein the computing device is configured to render a 3D simulation of an event in the facility over the 3D model.

14. The system of claim 9, wherein the received information includes video images.

15. A computing device for providing 3D facility monitoring, comprising:
a memory; and
a processor configured to execute instructions stored on the memory to:
receive facility alarm information determined by at least one of a plurality of facility systems during an alarm; and
display the facility alarm information over a 3D model of the facility, wherein the 3D model includes a plurality of virtual objects, and wherein each virtual object represents a respective portion of the facility.

16. The computing device of claim 15, wherein the plurality of virtual objects include:
a virtual object configured to represent a building of the facility; and
a virtual object configured to represent an equipment item in the facility.

17. The computing device of claim 15, wherein the computing device is configured to:
determine a location of the alarm in the facility; and
display a portion of the 3D model of the facility corresponding to the determined location of the alarm.

18. The computing device of claim 15, wherein the computing device is configured to:
determine an intensity of the alarm; and
display the determined intensity over the 3D model of the facility.

19. The computing device of claim 15, wherein the computing device is configured to display a particular portion of the facility alarm information corresponding to a particular facility system of the plurality of facility systems responsive to a user selection of the particular facility system.

20. The computing device of claim 15, wherein the computing device is configured to:
allow a user to select an object of the plurality of virtual objects via a display of the computing device;
display information associated with the selected object responsive to the selection; and
allow the user to modify a status of a device associated with the object responsive to the selection.
